(19) United States
(12) Patent Application Publication
(10) Pub. No.: US 2014/0219663 A1
(43) Pub. Date: Aug. 7, 2014

(54) METHODS AND ARRANGEMENTS FOR FREQUENCY SHIFT COMMUNICATIONS

(71) Applicant: Richard D. Roberts, Hillsboro, OR (US)

(72) Inventor: Richard D. Roberts, Hillsboro, OR (US)

(21) Appl. No.: 13/977,695

(22) PCT Filed: Sep. 30, 2011
(86) PCT No.: PCT/US2011/054441

§ 371 Date: Mar. 12, 2014

(51) Int. Cl. H04B 10/516; H04L 27/14; H04B 10/54; H04B 10/556; H04B 10/524

(52) U.S. Cl. CPC H04B 10/5161; H04B 10/5563; H04B 10/524; H04B 10/541; H04L 27/14
USPC 398/185

(57) ABSTRACT

Embodiments relate to communicating data by varying a frequency of an amplitude modulated light source. Embodiments may comprise logic such as hardware and/or code to vary a frequency of an amplitude-modulated electromagnetic radiator such as a visible light source, an infrared light source, or an ultraviolet light source. For instance, a visible light source such as a light emitting diode (LED) may provide light for a room in a commercial or residential building. The LED may be amplitude modulated by imposing a duty cycle that turns the LED on and off. In some embodiments, the LED may be amplitude modulated to offer the ability to adjust the intensity of the light emitted from the LED. Embodiments may receive a data signal and adjust the frequency of the light emitted from the LED to communicate the data signal via the light. In many embodiments, the data signal may be communicated via the light source at frequencies that are not perceivable via a human eye.

### BACKGROUND

The present disclosure relates generally to communication technologies. More particularly, the present disclosure relates to communicating data by varying a frequency of an amplitude-modulated light source.

### BRIEF DESCRIPTION OF THE DRAWINGS

FIG. 1 depicts an embodiment of a system including devices to transmit and to receive data communicated by varying a frequency of an amplitude-modulated light source;

FIG. 2 depicts an embodiment of apparatuses to transmit and to receive data communicated by varying a frequency of amplitude-modulation of a light source light source;

FIG. 3 illustrates alternative embodiments of a frequency shift keying (FSK) modulator;

FIG. 4 illustrates a flow chart of an embodiment to transmit data by varying a frequency of an amplitude-modulated light source; and

FIG. 5 illustrates a flow chart of an embodiment to receive data by varying a frequency of an amplitude-modulated light source.

### DETAILED DESCRIPTION OF EMBODIMENTS

The following is a detailed description of novel embodiments depicted in the accompanying drawings. However, the amount of detail offered is not intended to limit anticipated variations of the described embodiments; on the contrary, the claims and detailed description are to cover all modifications, equivalents, and alternatives falling within the spirit and scope of the present teachings as defined by the appended claims. The detailed descriptions below are designed to make such embodiments understandable to a person having ordinary skill in the art.

Generally, smart sensors, logic to process messages from smart sensors, and smart sensor systems are described herein. Logic, modules, devices, and interfaces herein described may perform functions that may be implemented in hardware and/or code. Hardware and/or code may comprise software, firmware, microcode, processors, state machines, chipsets, or combinations thereof designed to accomplish the functionality.

Embodiments relate to communicating data by varying a frequency of an amplitude modulated light source. Embodiments may comprise logic such as hardware and/or code to vary a frequency of an amplitude-modulated light source such as a visible light source, an infrared light source, or an ultraviolet light source. For instance, a visible light source such as a light emitting diode (LED) may provide light for a room in a commercial or residential building. The LED may be amplitude modulated by imposing a duty cycle that turns the LED on and off. In some embodiments, the LED may be amplitude modulated to offer the ability to adjust the perceivable brightness, or intensity, of the light emitted from the LED. Embodiments may receive a data signal and adjust the frequency of the light emitted from the LED to communicate the data signal via the light. In many embodiments, the data signal may be communicated via the light source at frequencies that are not perceivable via a human eye.

Embodiments may facilitate wireless communications. Wireless embodiments may integrate low power wireless communications like Bluetooth®, wireless local area networks (WLANs), wireless metropolitan area networks (WMANs), wireless personal area networks (WPAN), cellular networks, and/or Institute of Electrical and Electronic Engineers (IEEE) standard 802.15.4, “Wireless Medium Access Control (MAC) and Physical Layer (PHY) Specifications for Low Rate Wireless Personal Area Networks (LR-WPANs)” (2006) (http://standards.ieee.org/getieee802/download/802.15.4-2006.pdf), communications in networks, messaging systems, and smart-devices to facilitate interaction between such devices. Furthermore, some wireless embodiments may incorporate a single antenna while other embodiments may employ multiple antennas. For instance, multiple-input and multiple-output (MIMO) is the use of multiple antennas at both the transmitter and receiver to improve communication performance.

While some of the specific embodiments described below will reference the embodiments with specific configurations, those of skill in the art will realize that embodiments of the present disclosure may advantageously be implemented with other configurations with similar issues or problems.

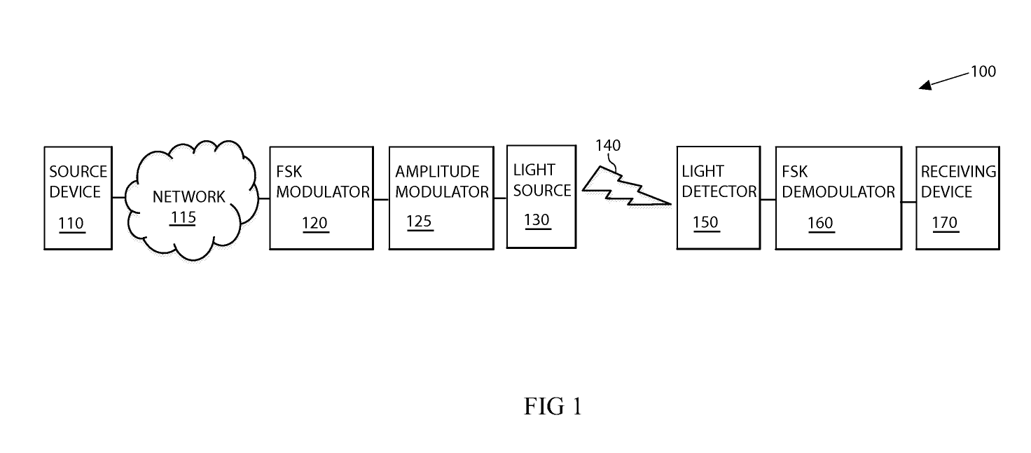

Turning now to FIG. 1, there is shown an embodiment of a system 100 system including devices to transmit and to receive data communicated by varying a frequency of an amplitude-modulated light source. System 100 comprises a source device 110, a network 115, a frequency shift keying (FSK) modulator 120, an amplitude modulator 125, a light source 130 to transmit light 140, a light detector 150, an FSK demodulator 160, and a receiving device 170. System 100 may communicate data originating from the source device 110 to the receiving device 170 wirelessly via the light source 130. For example, the light source 130 may be a visible light source to provide light for a conference room in a building. The speaker for the conference may provide a slide show presentation and notes related to the slides may be communication to receiving devices such as laptops of persons attending the conference.

The source device 110 may comprise a local network interface to communicatively couple the source device 110 with the FSK modulator 120 via the network 115. The network 115 may comprise a physical and/or wireless network such as a corporate intranet, wireless local area network (WLAN), a local area network (LAN), or other network capable of communicating data between devices.

The source device 110 may transmit a data signal to the FSK modulator 120 so the data may be transmitted to the receiving device 170. In some embodiments, the source device 110 may comprise a processor-based device such as a desktop computer, a notebook, a laptop, a Netbook, a smartphone, a server, or the like that is capable of transmitting a data signal to the FSK modulator 120.

The FSK modulator 120 may receive the data signal from the source device 110 and couple with the amplitude modulator 125 to modulate the light 140 emitted by the light source 130 in a pattern that facilitates communication of data from the data signal. In particular, the FSK modulator 120 may modulate the frequency of the light 140 and the amplitude modulator 125 may modulate the amplitude of the light 140. Modulation of the frequency of amplitude-modulated light 140 may identify data that is being transmitted by the light source.

For embodiments that utilize a visible light source 130, the light 140 may be modulated at a frequency that is not visible to the human eye such as approximately 100 Kilohertz (KHz). The FSK modulator 120 may modulate the light 140 emitted from the light source 130 via the amplitude modulator 125 by switching the power to the light source 130 to turn the light 140 on and turn the light 140 off at approximately 100 KHz. To transmit the data signal from the source device 110, the FSK modulator 120 may group bits of the data signal from the source device 110 and adjust the frequency of modulation of the light 140 to represent the groups. For instance, for embodiments in which the FSK modulator 120 groups logical zeros into a first group and logical ones into a second group, the FSK modulator 120 may adjust the frequency of modulation of the light 140 from the 100 KHz to, e.g., 90 KHz for a logical zero and 110 KHz for a logical one. In further embodiments, the FSK modulator 120 may adjust the frequency of modulation of the light 140 into four distinct frequencies for four distinct groups such as 80 KHz, 90 KHz, 100 KHz, and 110 KHz for groups of data comprising two bits, such as 00, 01, 10, and 11, respectively. In still further embodiments, more that two bits may be included in one or more of the groups of bits from the data signal.

The light source 130 may comprise an electromagnetic radiator that can be amplitude modulated such as a light emitting diode. The amount of data that may be communicated via, e.g., a visible light source without producing flicker perceivable by a human eye can vary based upon the speed with which the light source 130 can be amplitude modulated. In some embodiments, the light source 130 may comprise a visible light source. In some embodiments, the light source 130 may comprise an infrared light source. And, in some embodiments, the light source 130 may comprise an ultraviolet light source.

The light source 130 emits modulated light 140 with the data from the data signal at a location at which the light detector 150 can receive the light 140. The light detector 150 may convert the light 140 into an electrical signal. For example, the light detector 150 may comprise a photosensitive diode. The light detector 150 may couple with a power source and possibly other circuit elements to output a signal representative of the energy of the light 140 primarily at a frequency that is the frequency of modulation of the light 140. For instance, when the light 140 is modulated at 100 KHz, the energy received by the light detector 150 is primarily at 100 KHz and, thus, the electrical signal generated by the light detector 150 is primarily at 100 KHz.

The FSK demodulator 160 couples with the light detector 150 to receive the electrical signal, to determine the bit or bits represented by the light, and to output the bits to the receiving device 170. For example, for an embodiment in which a logical one is represented by 100 KHz, and a logical zero is represented by 80 KHz, the FSK demodulator 160 may comprise a first band-pass filter to filter out frequencies other than 100 KHz and a second band-pass filter to filter out frequencies other that 80 KHz. By comparing the energies associated with the two frequencies, the FSK demodulator 160 can determine the bit associated with the light 140 received by the light detector 150.

In some embodiments, the energy detected by the FSK demodulator 160 can represent more than one bits of data. For instance, energies associated with 100 KHz may represent two bits such as 01, three bits such as 010, or any other number or pattern of bits.

The receiving device 170 may comprise a processor-based device such as a desktop computer, a notebook, a laptop, a Netbook, a smartphone, a server, or the like that is capable of receiving data from the FSK demodulator 160. In some embodiments, the FSK demodulator 160 may be integral to the receiving device 170. In some of these embodiments, the light detector 150 may also be integral to the receiving device 170. For example, the light detector 150 may be a camera integral to a smart phone or notebook computer. In other embodiments, the light detector 160 may comprise a component to couple with a computer or other processor-based device to capture and display the data received through the light 140. In further embodiments, code residing on the receiving device 170 may utilize the data received via the light 140.

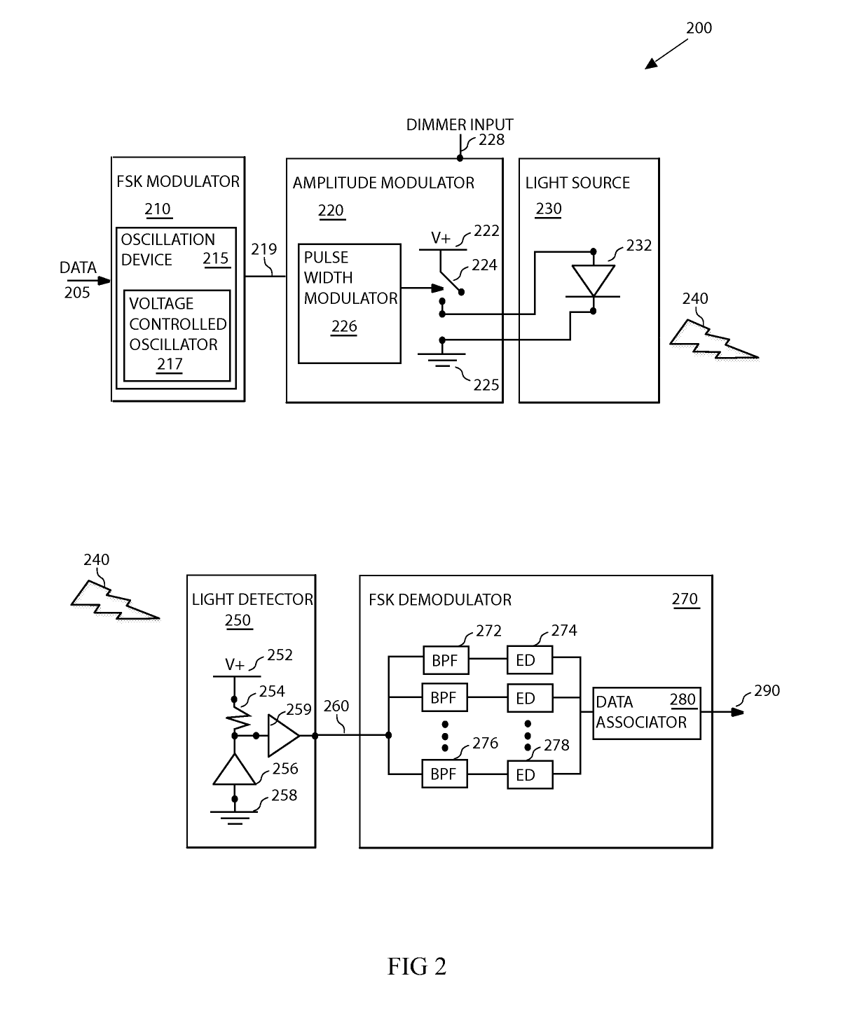

FIG. 2 depicts an embodiment of apparatuses 200 to transmit and to receive data 205 communicated by varying a frequency of amplitude modulation of a light source 230. For instance, lighting in a department store may communicate data to smart devices such as smart phones of customers to provide information about special sales or to offer coupons for products.

Apparatuses 200 comprise an FSK modulator 210, an amplitude modulator 220, a light source 230 to produce light 240, a light detector 250, and an FSK demodulator 270. The FSK modulator 210 may modulate the frequency of amplitude modulation of the light 240 based upon the data 205. FSK modulator 210 may comprise an oscillation device 215 to oscillate an output signal 219 at frequencies representative of one or more bits of the data 205. For example, the oscillation device 215 may comprise a voltage-controlled oscillator (VCO) 217. The VCO 217 may receive a voltage representative of, e.g., a logical one, such as five volts direct current (VDC) and, in response, may generate the output signal 219 at a frequency representative of the logical one such as 110 KHz. The VCO 217 may then receive a bit of the data representative of, e.g., a logical zero, such as zero volts and, in response, may generate the output signal 219 at a frequency representative of the logical zero such as 90 KHz.

The input of amplitude modulator 220 couples with the output of FSK modulator 210 to receive the output signal 219. The amplitude modulator 220 may utilize the output signal 219 to connect and disconnect the light source 230 from a power source 222. In the present embodiment, the amplitude modulator is illustrated as a switch 224 that opens and closes at the frequency of the output signal 219. For instance, when the switch 224 is open, the circuit between the voltage illustrated as the power source 222 and ground 225 is opened, turning off the LED 232. When the switch 224 is closed, the circuit between the voltage illustrated as the power source 222 and ground 225 is closed, drawing a current from the power source 222 through the LED 232, turning on the LED 232 to generate light 240. In some embodiments, the switch 224 may comprise one or more transistors. While the present embodiment illustrates the LED 232, embodiments may utilize an electromagnetic generator that can be amplitude modulated.

The light 240 may comprise light that is modulated between two or more states such as an “off” state and an “on” state at a frequency of the output signal 219. In several embodiments, the light comprises visible light. In other embodiments, light source 230 may generate infrared light, ultraviolet light, or visible light. In further embodiments, the light source 230 may switch between two different “on” states such as a full-power state in which the full-rated current or voltage for the light source 230 is applied to the light source 230 and a half-power state in which half the rated current or voltage is applied to the light source 230 to generate the light 240. In still further embodiments, the light source 230 may comprise multiple sources such as multiple LEDs and less than all of the light sources may be turned off to create a “partially on” state for modulation.

In some embodiments, amplitude modulator 220 comprises pulse-width modulation logic 226 to adjust the duty cycle of the light 240 or, in other words, vary the percentage of time that the light source 232 is on. For instance, the duty cycle of the light 240 without the pulse-width modulation logic 226 may be at 50 percent. The 50 percent duty cycle means that the light 240 generated by the LED 232 is on 50 percent of the time and off 50 percent of the time. The effect of the 50 percent duty cycle is that the intensity of the light 240 is half of the intensity if the LED 232 were turned on 100 percent of the time, i.e., no amplitude modulation. The pulse-width modulation logic 226 may adjust the percentage of time that the light source 230 is on during the duty cycle to provide a dimming circuit for the light source 230. For example, the pulse-width modulation logic 226 may be adjustable via a knob or switch for the light source 230 so a user may dim the light 240 or increase the brightness or intensity of the light 240 via a dimmer input 228 while the light 240 is still modulated at the frequency of the output signal 219.

A receiving device may receive the light 240, such as the receiving device 170 in FIG. 1, via a light detector 250 and an FSK demodulator 270. The light detector 250 may receive the light 240 and generate an electrical signal 260 based upon the light 240 at a frequency of the amplitude modulation of the light 240. For instance, when the amplitude modulator 220 modulates the light 240 at a frequency of 110 KHz, the light detector 250 may generate an electrical signal 260 with energy primarily transmitted at 110 KHz. In the present embodiment, the light detector 250 comprises a circuit including a power source 252, a resistance 254, a photo-sensitive diode 256, a ground 258 and an output buffer 259 coupled between the resistance 254 and the photo-sensitive diode 256 to output an electrical signal 260. The resistance 254 may establish a current through the photosensitive diode 256 in response to the photosensitive diode 256 receiving the light 240. In other embodiments, the light detector 250 may comprise different elements and may apply different voltage levels rather than a voltage and a ground.

The photosensitive diode 256 may block or substantially attenuate current between the power source 252 and ground 258 when the photosensitive diode 256 is not receiving light and may provide little or no resistance to a current while the light 240 is being received by the photosensitive diode 256. As a result, the voltage drop across the resistance 254 may vary at the same frequency that the light 240 turns on and off. In other embodiments, if the light 240 modulates between a full-on state and a second state that is also an on state, the extent of the voltage drop across the resistance 254 may change at the frequency at which the light 240 changes between the two on states.

The FSK demodulator 270 detects the frequency of changes in the electrical signal 260 and translates the changes into data 290. In the present embodiment, the FSK demodulator 270 includes a band-pass filter for each frequency that the FSK demodulator 270 may receive such as band-pass filters 272 through 276. The FSK demodulator 270 may, for instance, include a band-pass filter for 90 KHz and a band-pass filter for 110 KHz. In other embodiments, more than two band-pass filters may be used.

The band-pass filters 272 through 276 may be coupled with energy detectors 274 through 278. The energy detectors 274 through 278 may measure energy received at a particular frequency so the energies of each frequency may be compared with the energies at other frequencies to determine which frequency is the frequency of modulation of the light 240.

In one embodiment, a single band-pass filter is implemented. For example, the FSK demodulator may expect to receive energy at a particular level to indicate that the light 240 is modulated at one frequency. Thus, the FSK demodulator 270 may determine that the light 240 is being modulated at the one frequency if the energy captured from the electrical signal reaches a certain threshold energy. In another embodiment that utilizes one band-pass filter, the energy received at an energy detector connected to the band-pass filter may be compared with the total energy received via the electrical signal 260 to determine whether the relative energy that passed through the band-pass filter is a sufficiently high percentage of the total energy from the electrical signal 260 to determine that the frequency associated with the band-pass filter is the frequency of the light 240.

The FSK demodulator 270 may also comprise a data associator 280. The data associator 280 may comprise logic to compare energies from energy detectors 274 through 278 associate electrical signal 260 with a frequency, associating the light 240 with data 290 to output. For instance, some embodiments include two band-pass filters 272 and 276. The band-pass filter 272 may filter out most frequencies from the electrical signal 260 other than 90 KHz and energy detector 274 may couple with band-pass filter 272 to determine an energy associated with 90 KHz. The band-pass filter 276 may filter out frequencies other than 110 KHz and the energy detector 278 may determine the energy associated with 110 KHz. The data associator 280 may receive as inputs, indications of the energy levels from the energy detectors 274 and 278 and may compare the energy levels to determine whether the primary frequency of the electrical signal 260 is at 90 KHz or at 110 KHz. For embodiments in which 90 KHz is associated with a logical zero and 110 KHz is associated with a logical one, the data associator 280 may output a logical zero as data 290 if the energy level indicated by the energy detector 274 is determined to be greater than the energy level detected by the energy detector 278. And the data associator 280 may output a logical one as data 290 if the energy level indicated by the energy detector 278 is determined to be greater than the energy level detected by the energy detector 274.

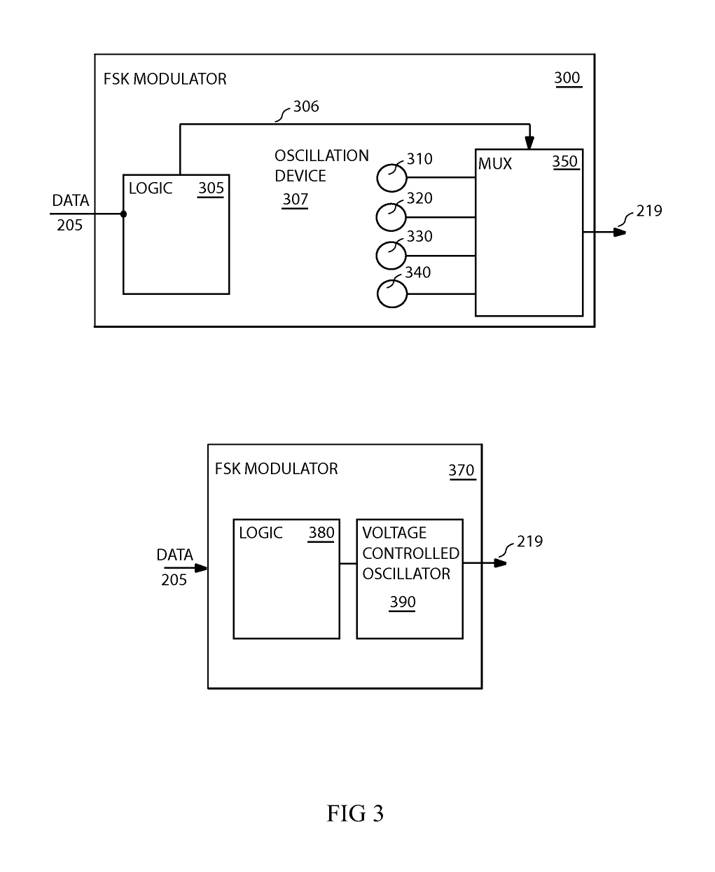

Referring also to FIG. 3, there is shown alternative embodiments (FSK modulators 300 and 370) of the FSK modulator 210 shown in FIG. 2. FSK modulator 300 comprises logic 305, oscillators 310-340, and multiplexer 350. Other embodiments implement different circuit elements to accomplish the same output.

Logic 305 may comprise a circuit to associate inputs of bits of data with distinct outputs. In one embodiment, for example, logic 305 comprises a domino logic circuit. Logic 305 receives data 205 and identifies two or more groups, each comprising two or more bits. After identifying a group of bits, logic 305 outputs a selection signal 306 associated with the group of bits to MUX 350. A number of different frequency signals from oscillators 310, 320, 330, and 340 are coupled with the input of MUX 350. For instance, oscillator 310 may output a signal with a frequency of 90 KHz, oscillator 320 may output a signal with a frequency of 100 KHz, oscillator 330 may output a signal with a frequency of 110 KHz, and oscillator 310 may output a signal with a frequency of 120 KHz. The present embodiment illustrates four input signals but other embodiments may comprise any number of input signals.

MUX 350 selects the appropriate frequency signal as the output signal 219 based upon the selection signal 306 from logic 305. For example, logic 305 may output a selection signal 306 representing each of the groups of bits such as two consecutive logical zeros (00), a consecutive logical zero and logical one (01), a consecutive logical one and logical zero (10), and two consecutive logical ones (11). Other embodiments may utilize different selection signals and some embodiments may utilize more combinations of bits such as three bits, four bits, five bits, or the like.

FSK modulator 370 comprises logic 380 coupled with VCO 390. In this embodiment, the voltage of the output from logic 380 determines the frequency of the output signal 219 from VCO 390. For example, logic 380 may output a selection signal of zero volts in response to receipt of two consecutive logical zeros (00), three volts in response to receipt of a consecutive logical zero and logical one (01), six volts in response to receipt of a consecutive logical one and logical zero (10), and nine volts in response to receipt of two consecutive logical ones (11). Other embodiments may utilize different voltages and some embodiments may utilize more combinations of bits such as three bits, four bits, five bits, or the like.

In further embodiments, FSK modulator 370 may couple other circuit elements with the output of VCO 390 to adjust characteristics of the output to generate output signal 219. For instance, a capacitance and/or resistance may filter the output of the VCO 390 to generate output signal 219. In other embodiments, a couple transistors coupled with the output of the VCO 390 may convert the output into a square wave at a selected voltage.

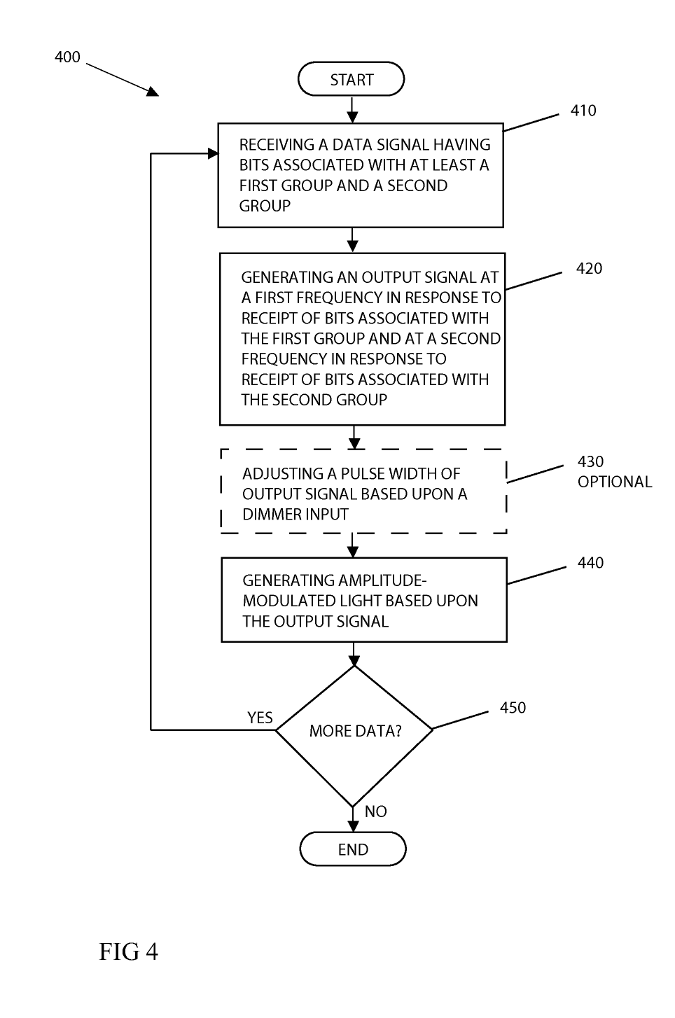

FIG. 4 illustrates a flow chart 400 of an embodiment to transmit data by varying a frequency of an amplitude-modulated light source. The embodiment involves transmission of data via a light source such as is described with respect to FIGS. 1-3. Flow chart 400 begins with receiving, by a frequency shift keying (FSK) modulator, a data signal having bits associated with at least a first group and a second group, wherein the first group is associated with a first frequency and the second group is associated with a second frequency (element 410). For example, the FSK modulator may receive the data signal and as the data is received via the data signal, the FSK modulator may determine variations in the frequency of amplitude modulation of the light source to transmit the data from the data signal to a receiving device via the light emanating from the light source. Note that the light source may comprise any electromagnetic radiator that can be amplitude modulated.

The FSK modulator may divide the data into groups and associate each of the groups of data with a different frequency. For instance, the groups may comprise groups of 1 bit such as a first group comprising logical ones and a second group comprising logical zeros. In other embodiments, groups may represent symbols of more than one bits of data. One example of a group representing symbols of data is a first group representing a bit pattern of all logical zeros such as 0000, a second group representing a bit pattern of logical ones and zeros such as 0001, a third group representing a bit pattern of logical ones and zeros such as 0010, a fourth group representing a bit pattern of logical ones and zeros such as 0011, and so on. In other embodiments, the symbols represented by the groups may include more specific and complex sets of data such as groups of bits representing encoded instructions. In further embodiments, some groups may represent a number of bits and other groups may represent instructions such as high-level commands for a processor-based device to display text or an object of a screen of the processor-based device.

Upon receiving data of a data signal, the FSK modulator may generate an output signal at the first frequency in response to receipt of bits associated with the first group (element 420) and may generate the output signal at the second frequency in response to receipt of bits associated with the second group (element 430). For instance, for embodiments in which two bits represent a group, the FSK modulator may receive a logical 00 and generate a first frequency representative of the logical 00. The FSK modulator may then receive a logical 10 and generate a third frequency representative of the logical 10. The FSK modulator may continue to generate the various frequencies representative of the data received via the data signal until no more data (element 450) is received via the data signal.

In some embodiments, after generating the first frequency representative of the logical 00, the FSK modulator may couple with a pulse width modulator to apply pulse-width modulation to the light source to impose a duty cycle based upon input such as input from a dimmer switch (element 430). The pulse width modulator may maintain the first frequency as the frequency of modulation of the light source while adjusting the pulse width to adjust the intensity of the light emitted from the light source.

After generating the first frequency representative of the logical 00, the FSK modulator may apply the frequency to a light source via an amplitude modulator to adjust the frequency of amplitude modulation to the first frequency (element 440). After receiving more data (element 450) such as the logical 10, the FSK modulator may change the output signal to the third frequency to represent the logical 10 and may apply the third frequency to the light source to adjust the frequency of amplitude modulation to the third frequency (element 440).

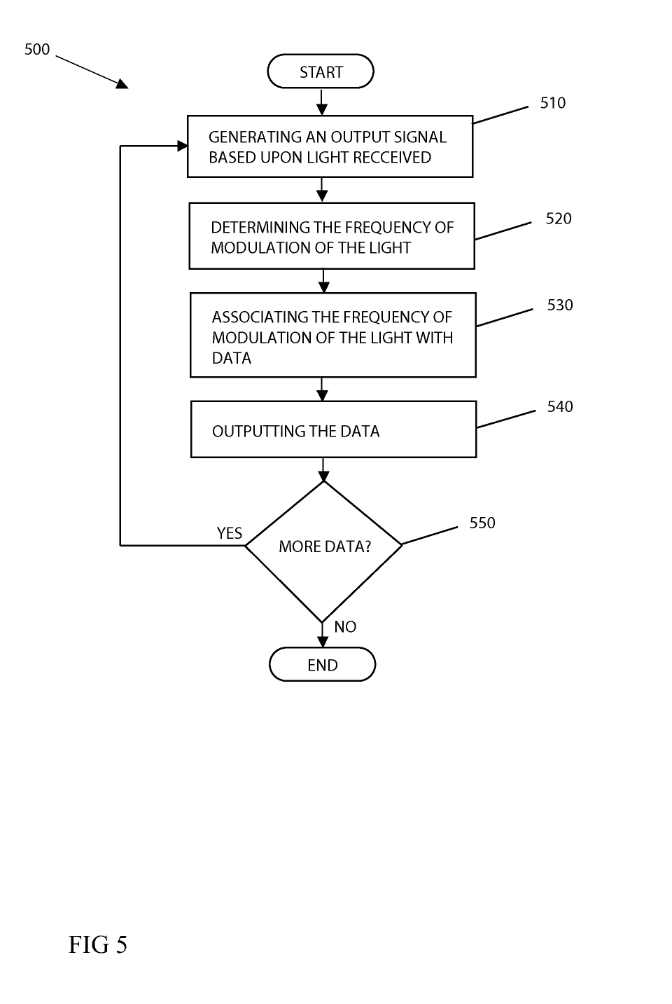

FIG. 5 illustrates a flow chart 500 of an embodiment to receive data by varying a frequency of an amplitude-modulated light source. Flow chart 500 begins with generating an output signal based upon light received (element 510). For example, a light detector may receive light and, in response generate an output signal such as an electrical signal that has characteristics similar to the light received. The characteristics may include the frequency at which the light is amplitude modulated. In some embodiments, the light may be visible light while, in other embodiments, the light may be infrared light or ultraviolet light.

The FSK demodulator may receive the output signal from the light detector and determine, based upon the characteristics of the output signal, the data that the light represents. In many embodiments, the FSK demodulator may comprise logic to determine the frequency of the modulation of the light received (element 520) and, based upon the frequency, determine data or one or more bits of data to associate with the light (element 530). For instance, the light may be amplitude modulated at a frequency of 120 KHz. The FSK modulator may determine the frequency of the amplitude modulation of the light and associate the light with a pattern of logical ones and zeros such as two consecutive logical ones, 11. In some embodiments, the FSK demodulator may comprise a data associator to associate frequencies with data. In many embodiments, the data associator may utilize a table that associates frequencies of modulation of light with data. In other embodiments, the data associator may comprise logic to associate the frequencies with data. And, in some embodiments, the logic may comprise a state machine to associate the frequencies with data.

FSK demodulator may output the data associated with the light (element 540) and then determine whether additional data is transmitted via the light (element 550). Determining the additional data may occur in parallel with processing the output from the light detector, with associating the data with the frequency of the light, and/or with outputting the data. For example, in some embodiments, the FSK demodulator is implemented within a processor-based device such as a smart phone or a laptop. A camera built-into or otherwise coupled with the processor-based device may operate as the light detector and the FSK demodulator may comprise logic in the form of code and/or hardware within the processor-based device. In other embodiments, the FSK demodulator may be a distinct device and may couple with the processor-based device.

Another embodiment is implemented as a program product for implementing systems and methods described with reference to FIGS. 1-5. Embodiments can take the form of an entirely hardware embodiment, an entirely software embodiment, or an embodiment containing both hardware and software elements. One embodiment is implemented in software, which includes but is not limited to firmware, resident software, microcode, etc.

Furthermore, embodiments can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem, and Ethernet adapter cards are just a few of the currently available types of network adapters.

The logic as described above may be part of the design for an integrated circuit chip. The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher level carrier) or in a multichip package (such as a ceramic carrier that has either or both surface interconnections or buried interconnections). In any case, the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

It will be apparent to those skilled in the art having the benefit of this disclosure that the present disclosure contemplates smart sensors. It is understood that the form of the embodiments shown and described in the detailed description and the drawings are to be taken merely as examples. It is intended that the following claims be interpreted broadly to embrace all variations of the example embodiments disclosed.

Although the present disclosure has been described in detail for some embodiments, it should be understood that various changes, substitutions, and alterations could be made herein without departing from the spirit and scope of the disclosure as defined by the appended claims. Although specific embodiments may achieve multiple objectives, not every embodiment falling within the scope of the attached claims will achieve every objective. Moreover, the scope of the present application is not intended to be limited to the particular embodiments of the process, machine, manufacture, composition of matter, means, methods, and steps described in the specification. As one of ordinary skill in the art will readily appreciate from this disclosure, processes, machines, manufacture, compositions of matter, means, methods, or steps presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A method comprising:
receiving, by a frequency shift keying modulator, a data signal having bits associated with at least a first group and a second group, wherein the first group is associated with a first frequency and the second group is associated with a second frequency;
generating, by the frequency shift keying modulator, an output signal at the first frequency in response to receipt of bits associated with the first group;
generating, by the frequency shift keying modulator, the output signal at the second frequency in response to receipt of bits associated with the second group; and
applying, by the frequency shift keying modulator, the output signal to a light source to generate light comprising the data.

2. The method of claim 1, further comprising applying pulse-width modulation to the light source to impose a duty cycle.

3. The method of claim 1, further comprising varying a pulse width of power supplied to the light source to adjust the intensity of the light generated by the light source.

4. The method of claim 1, further comprising generating, by the frequency shift keying modulator, the output signal at a third frequency in response to receiving bits associated with a third group in the data signal and generating, by the frequency shift keying device, the output signal at a fourth frequency in response to receiving bits associated with a fourth group in the data signal.

5. The method of claim 1, wherein generating, by the frequency shift keying modulator, the output signal at the first frequency comprises generating light modulated at the first frequency in response to a logical one in the data signal.

6. The method of claim 1, wherein generating, by the frequency shift keying modulator, the output signal at the first frequency comprises generating light modulated at the first frequency in response to receiving a group comprising two consecutive logical ones in the data signal.

7. The method of claim 1, wherein generating, by the frequency shift keying modulator, the output signal at the second frequency comprises generating light modulated at the second frequency in response to a logical zero in the data signal.

8. The method of claim 1, wherein applying, by the frequency shift keying modulator, the output signal to a light source to generate light comprising the data comprises applying the output signal to a light emitting diode (LED).

9. An apparatus comprising:
an oscillation device to receive a data signal having bits associated with at least a first group and a second group, wherein the first group is associated with a first frequency and the second group is associated with a second frequency; to generate an output signal at the first frequency in response to receipt of bits associated with the first group; and to generate the output signal at the second frequency in response to receipt of bits associated with the second group; and
an amplitude modulation device to modulate the amplitude of power to apply to a light source at the frequency of the output signal to generate light comprising the data.

10. The apparatus of claim 9, further comprising a pulse width modulator to modulate the pulse width of the power to apply to the light source to adjust the intensity of the light emitted by the light source.

11. The apparatus of claim 9, further comprising a light source.

12. The apparatus of claim 11, wherein the light source comprises at least one light source from a group of light sources comprising an infrared light source, a visible light source, and an ultraviolet light source.

13. The apparatus of claim 9, wherein the oscillation device comprises a voltage controlled oscillator to vary the frequency of the output signal based upon the value of bits in the data signal.

14. The apparatus of claim 9, wherein the oscillation device comprises more than one oscillator to vary the frequency of the output signal based upon the value of bits in the data signal.

15. The apparatus of claim 9, wherein the amplitude modulation device comprises one or more transistors to modulate the power applied to the light source.

16. An apparatus comprising:
a light detector to output an electrical signal based upon light received; and
a receiving device to filter the electrical signal to determine data received via the light and to output data received by filtering the electrical signal, comparing energy associated with each of more than one frequencies to determine the frequencies associated with modulation of the light, and associating the frequencies associated with modulation of the light with bits of data.

17. The apparatus of claim 16, wherein the light detector comprises a photodiode.

18. The apparatus of claim 16, wherein the receiving device comprises a first band-pass filter to filter the electrical signal to include energy associated with a first frequency, and a second band-pass filter to filter the electrical signal to include energy associated with a second frequency.

19. The apparatus of claim 18, wherein the receiving device comprises a first energy detector determine an energy associated with the first frequency and a second energy detector determine an energy associated with the second frequency.

20. The apparatus of claim 19, wherein the receiving device comprises a data associator to associate data with the electrical signal based upon comparison of the energies associated with the first frequency and the second frequency.

21. The apparatus of claim 16, wherein the receiving device comprises more than two band-pass filters and more than two energy detectors to associate data with more than two different frequencies.

22. An system comprising:
a processor-based device to generate a data signal having bits associated with at least a first group and a second group, wherein the first group is associated with a first frequency and the second group is associated with a second frequency; and
a frequency shift keying device communicatively coupled with the processor-based device to receive the data signal, to generate an output signal at the first frequency in response to receipt of bits associated with the first group, to generate the output signal at the second frequency in response to receipt of bits associated with the second group; and to apply the output signal to a light source to generate light comprising the data.

23. The system of claim 22, further comprising the light source.

24. The system of claim 22, wherein the frequency shift keying device comprises a pulse width to impose a duty cycle on power provided to the light source.

25. The system of claim 22, wherein the frequency shift keying device is communicatively coupled with the processor-based device via a wireless network.

26. (canceled)
